(19) United States
(12) Patent Application Publication
(10) Pub. No.: US 2024/0360300 A1
(43) Pub. Date: Oct. 31, 2024

(54) POLYOLEFIN COMPOSITION WITH IONOMERIC CAVITATION AGENT

(71) Applicant: VOID TECHNOLOGIES LIMITED, Buckinghamshire (GB)

(72) Inventors: Andrew Dennis BURTON, Neenah, WI (US); Peter John SCHULZ, Greenville, WI (US); Ryan James MCENEANY, Appleton, WI (US)

(73) Assignee: VOID TECHNOLOGIES LIMITED, Buckinghamshire (GB)

(21) Appl. No.: 18/647,436

(22) Filed: Apr. 26, 2024

Related U.S. Application Data
(60) Provisional application No. 63/462,718, filed on Apr. 28, 2023.

(51) Int. Cl. C08L 23/06

(52) U.S. Cl. CPC C08L 23/06; C08L 2207/066

(57) ABSTRACT

Disclosed are polymeric compositions useful for making articles containing cavities. The compositions include a continuous polymeric phase and a cavitation agent dispersed in the continuous polymeric phase. The continuous polymeric phase includes a polyolefin, and the cavitation agent includes an ionomer, except for ethylene-based and propylene-based ionomers. Cavitating polyolefins with ionomeric cavitation agents can offer various advantages, such as a lower cavitated film density at colder extrusion temperatures and a lower cavitated film density at higher orientation temperatures.

### CROSS-REFERENCE TO RELATED APPLICATIONS

This application claims the benefit of the filing date of U.S. Provisional Patent Application No. 63/462,718 filed on Apr. 28, 2023, under 35 U.S.C. § 119 (e); the entire content of the provisional application is hereby incorporated by reference. This application is also related to International Application No. PCT/US2024/026473 filed on Apr. 26, 2024; the entire content of which is also hereby incorporated by reference.

### FIELD OF THE INVENTION

The invention pertains to the field of polymeric compositions. In particular, the invention relates to compositions useful for forming articles containing cavities, the articles and products containing the articles, and methods of making the articles.

### BACKGROUND OF THE INVENTION

Cavitated articles can be produced from polymeric compositions containing small particles or inclusions (called “cavitation” or “voiding” agents) using various converting technologies for producing film, sheet, and fiber. Conventional converting processes use plastic extrusion and a die to form the article. For films, the film can be formed via a cast or a blown-film extrusion process. For cast film or sheet, the molten polymer exits a die and is cooled on a chill roll. In a blown-film setup, the film exits the die and is formed into a tube where air fills the interior of the tube forming a bubble structure. The top of the bubble is collapsed in a frame and pulled by a set of nip rolls. In both setups, the film is optionally trimmed. In both film-converting processes, the molten polymer is melt oriented as it exits the die. The melt orientation upon exiting the die is not where the majority of the cavity volume is formed. After forming the article, it is typically cooled.

Once the article is formed and cooled from the converting process, it can then be stretched (oriented), typically in-line with the extrusion process, through three different orientation processes: (a) machine direction orientation (MDO); (b) transverse direction orientation (TDO); or (c) biaxial orientation (Biax), which includes both a machine direction and a transverse direction orientation in either sequential or simultaneous mode. The orientation process along with the cavitation agent forms cavities within the continuous polymeric phase. When cavities are formed in polymeric films, the cavitated films tend to have lower densities and higher opacities than their non-cavitated counterparts.

Cavitating polymers with polymeric cavitation agents is well documented in the literature and in patents. Polymeric cavitation agents, however, have only had limited success, with most being combined with inorganic cavitation agents, which themselves have limiting attributes (see, for example, U.S. Pat. No. 4,770,931).

Commercially available polymers suffer from various problems when used as cavitation agents in polyolefin matrices. These problems include:
1. They tend to break up into droplets that are smaller in diameter than desired, resulting in higher film density and lower opacity after stretching.
2. They tend to deform into elongated shapes (e.g., platelets or ellipsoids) during the extrusion process, where spherical cavitation agents are most desirable for cavitating efficiency.
3. They tend to only marginally decrease cavitated film densities. The extrusion and orientation process window is very narrow to achieve commercially relevant film properties. For example, higher extrusion temperatures can cause bubble instability and low extrusion rates, which decrease asset utilization; and cold orientation conditions can lead to film breaks or holes. But decreasing extrusion temperatures and increasing orientation temperatures can lead to higher cavitated film densities.
4. They tend to be incompatible for melt processing with the continuous polymeric phase. Certain polymers may be exceptional at cavitation, but they are not commercially viable due to their (a) melt temperatures exceeding the processing temperatures of the continuous polymeric phase or (b) reactivity or degradation at the required processing temperatures. Cavitation agents with poor melt-process compatibility may also be difficult to purge from the extrusion process, leading to contamination that can cause breaks during orientation or other quality defects.

To control breakup and deformation, polymer molecular weight (MW) and branching can be modified to increase the viscosity ratio of the inclusion phase to the continuous polymeric phase. However, this means that specialized polymers must be created, which increases cost. Additionally, high MW polymers may not melt process with the continuous polymeric phase.

Thus, there is a need in the art for more effective polymeric cavitation agents for polyolefin continuous phases, particularly agents that can resist deformation and breakup, that can provide improved density reduction after orientation, and that have good melt-process compatibility with a polyolefin continuous phase.

The present invention addresses this need as well as others, which will become apparent from the following description and the appended claims.

### SUMMARY OF THE INVENTION

The invention is as set forth in the appended claims.

Briefly, in one aspect, the present invention provides a composition comprising:
(A) a continuous polymeric phase comprising a polyolefin; and
(B) a cavitation agent dispersed in the continuous polymeric phase,
wherein the cavitation agent comprises one or more ionomers, and
wherein the one or more ionomers exclude ethylene-based ionomers and propylene-based ionomers.

In a second aspect, the invention provides a cavitated article comprising the composition of the invention.

The cavitated article can be used to create a range of products, such as bags (including woven bags), labels (including shrink labels), shrink films, laminates, standup pouches, wraps, straps, ribbons, strips, tapes, lids, trays, bowls, cups, bottles, yarns, fabrics (including woven raffia fabric), and clothing.

In a third aspect, the invention provides a method of making a cavitated article.

The method includes the steps of:
(a) forming a melt comprising the composition of the invention;
(b) forming an article from the melt;
(c) cooling the article, and optionally heating the article to an orientation temperature;
(d) orienting the article from step (c) in at least one direction to form a cavitated article; and
(e) optionally, (i) annealing the cavitated article at a temperature higher than the orientation temperature, (ii) allowing the cavitated article to contract in the direction of orientation, or both (i) and (ii); or
(f) optionally, (i) annealing the cavitated article at or below the orientation temperature to retain a desired shrink in the article, (ii) allowing the cavitated article to contract in the direction of orientation, or both (i) and (ii).

In various embodiments, the article prepared by the method may be a film, a sheet, a fiber, or a tube.

### DETAILED DESCRIPTION OF THE INVENTION

### Glossary

To facilitate understanding the invention, several terms are defined below. Those left undefined have meanings as commonly understood by a person of ordinary skill in the technical areas relevant to the present invention.

As used herein, the indefinite articles “a” and “an” mean one or more, unless the context clearly suggests otherwise. Similarly, the singular form of nouns includes their plural form, and vice versa, unless the context clearly suggests otherwise.

The term “acrylic-containing polymer” refers to a polymer where acrylic acid or methacrylic acid, their esters, or their salts constitute at least twenty mole percent of the polymer. Also included in the term “acrylic-containing polymer” are polymers where monomers that have more than one carboxylic acid, carboxylate ester, or carboxylate salt constitute at least ten mole percent of the polymer. Examples of monomers with more than one carboxylic acid, carboxylate ester, or carboxylate salt include itaconic acid, citric acid, maleic acid, fumaric acid, aconitic acid, and malic acid.

The terms “amide-based polymer” and “polyamide” are used interchangeably. They refer to a polymer with more than 50 percent of the repeating units being linked by amide bonds. The polymer may contain at least one other bond type. Amide-based polymers include homopolymers and copolymers (meaning more than one kind of monomer is used to form the amide-based polymer). Examples of amide-based polymers (polyamides) include aliphatic, semi-aromatic, and aromatic. Examples of aliphatic polyamides include polycaprolactam, poly(hexamethylene adipamide), poly(hexamethylene succinimide), polylaurolactam, poly(11-aminoundecanoic acid), and poly(hexamethylene sebacimide). Examples of semi-aromatic polyamides include poly(hexamethylene terephthalamide), poly(hexamethylene isophthalamide), and polymers utilizing both terephthalic acid and isophthalic acid along with an aliphatic diamine.

The term “article” refers to a shaped object. Examples of articles include a film, a sheet, a fiber, or a tube. The articles may be made of a single layer or multiple layers.

The term “carrier resin” refers to a polymeric resin that may be blended with the cavitation agent to form a composition in a separate step before extrusion into an article. This composition can be a masterbatch which may be combined with a letdown resin to form a fully compounded (or target) composition, or it can be the target composition itself. The carrier resin may be the same as or different from the letdown resin. The carrier resin will generally become a part or all of the continuous polymeric phase.

The term “cation component” is used to refer to a material that is, or contains, a positive ion (cation), and that can be used to neutralize one or more anions of a polymer to produce an ionomer. The cation component can be an alkali metal ion (e.g., Li+, Na+, K+, and Rb+), an alkaline earth metal ion (e.g., Mg++ and Ca++), a transition metal ion (e.g., Fe++, Fe+++, Co++, Ni++, Cu++, Zn++, and Ag++), an aluminum ion (Al+++), a polyatomic cation (e.g., guanidinium, ammonium, phosphonium, and pyrylium), or combinations thereof.

The term “cavitated article” refers to an article that has been subjected to monoaxial orientation (i.e., drawing or stretching in the machine direction or the transverse direction) or biaxial orientation (i.e., drawing or stretching in the machine direction and the transverse direction) and that has cavities or voids. In a tubular orientation process, such as a double-bubble or triple-bubble orientation process, the transverse direction is in the circumferential direction of the bubble and the machine direction is in the axial direction of travel of the tube. Orientation occurs in this process as air inflates the tube (expanding the diameter of the tube to impart transverse orientation) and nip rolls at the top of the tube accelerate the machine direction speed.

The terms “cavities” and “voids” are used interchangeably. They refer to areas within the cavitated article that are not occupied by the continuous polymeric phase or the cavitation agent. In other words, they are empty space within the cavitated article. The empty space may be occupied by a gas, such as air.

The terms “cavitation agent” and “voiding agent” are used interchangeably. They refer to one or more materials that can form cavities or voids within a polymer (continuous polymeric phase) during the orientation/stretching process. The cavitation agent can be organic or inorganic. Inorganic cavitation agents are typically in particulate form. Organic or polymeric cavitation agents typically have a degree of incompatibility with the continuous polymeric phase such that the two form different phases when mixed in the melt, where the cavitation agent (inclusion) forms a droplet phase within a continuous polymeric phase (matrix). The inclusion and the matrix ideally have poor or no adhesion to each other such that their bonding forces are low or non-existent.

The term “composition” refers to a mixture of materials which comprise the composition, as well as reaction products and decomposition products formed from the materials of the composition.

The terms “continuous polymeric phase” and “polymer matrix” or simply “matrix” are used interchangeably. They refer to a continuous domain formed by one or more polymers. Discrete domains formed from the cavitation agent do not form part of this phase, but can be dispersed throughout the phase.

The terms “ester-based polymer” and “polyester” are used interchangeably. They refer to a polymer with more than 50 percent of the repeating units being linked by ester bonds. The polymer may contain at least one other bond type. Ester-based polymers include homopolymers and copolymers (meaning more than one kind of monomer is used to form the ester-based polymer). Examples of ester-based polymers (polyesters) include aliphatic, semi-aromatic, and aromatic. Examples of aliphatic polyesters include polylactic acid, polyglycolic acid, polycaprolactone, polyhydroxybutyrate, and poly(3-hydroxybutyrate-co-3-hydroxyvalerate). Examples of semi-aromatic polyesters include poly(ethylene terephthalate), poly(butylene terephthalate), poly(ethylene naphthalate), poly(trimethylene terephatalate), polymers where some or all of the terephthalic acid is replaced by another aromatic dicarboxylic acid, and polymers where some or all of the diol is replaced by another non-aromatic glycol (e.g., polyethylene terephthalate glycol).

The term “ethylene-based ionomer” refers to an ethylene-based polymer that is an ionomer having a Tg below 100° C., for example, ethylene-(meth)acrylic acid copolymer with some or all of its anionic sites neutralized with sodium or zinc. A commercial example of an ethylene-based ionomer is SURLYN™ ionomer manufactured by The Dow Chemical Company.

The terms “ethylene-based polymer” and “polyethylene” are used interchangeably. They refer to a polymer that contains more than 50 mole percent (mole %) of polymerized ethylene monomer (based on the total amount of polymerizable monomers) and, optionally, may contain at least one comonomer. Ethylene-based polymer includes ethylene homopolymer and ethylene copolymer (meaning units derived from ethylene and one or more comonomers). Examples of ethylene-based polymer (polyethylene) include low-density polyethylene (LDPE) and linear polyethylene. Examples of linear polyethylene include linear low-density polyethylene (LLDPE), ultra-low-density polyethylene (ULDPE), very-low-density polyethylene (VLDPE), single-site catalyzed linear low-density polyethylene (m-LLDPE), substantially linear, or linear, plastomers/elastomers, and high-density polyethylene (HDPE). These polymers can be polymerized in a variety of methods known to the industry. The particular polymerization method, including the selection of catalyst where applicable, is typically selected based on compatibility with the monomer(s), the desired polymer architecture and properties, and economic factors.

The term “inclusions” is used to refer to the discrete domains formed by the cavitation agent within the continuous polymeric phase.

The term “ionomer” refers to a polymer having a combination of electrically neutral and neutralizable repeating units where the neutralizable component is a pendant group covalently bonded to the polymer backbone, and at least partially neutralized (“ionized”) with a cation. Usually, no more than 15 mole percent (e.g., 1 to 15 mole %) of the repeating units are ionized or can be ionized. The ionomer can be a polymer product of the neutralization of a precursor polymer component with a cation component. The ionomer can be formed in various ways, such as by (a) grafting a neutralizable monomer or an already neutralized monomer to a polymer, (b) neutralizing a neutralizable repeating unit that was copolymerized into the polymer backbone, and (c) copolymerizing an already neutralized repeating unit with a comonomer. Typically, ionomers are made by copolymerizing a monomer (e.g., ethylene or styrene) with carboxylic acid-containing comonomers (acrylic acid and methacrylic acid being the most common, but others, such as unsaturated acid anhydrides can be used as well) and then partially neutralizing the copolymer with a cation component. Other methods include copolymerization or grafting of sulfonic acid-containing monomers, or simply sulfur trioxide, or similar methods of incorporating phosphonic acid groups, followed by neutralization with a cation component.

The term “ionomer precursor” refers to (i) a polymer with one or more negative ions (anions) (or electrically charged repeating units) that can be neutralized by a cation component to produce an ionomer or (ii) a polymer formed by reaction of a non-neutralizable polymer with acid-functionalized monomers, oligomers, or polymers.

The term “letdown resin” refers to a polymeric resin that is blended with the cavitation agent or with a cavitation agent masterbatch during extrusion to form an article. The letdown resin will generally become a part or all of the continuous polymeric phase.

The term “masterbatch” refers to a composition that has a higher concentration of the cavitation agent than a fully compounded or a fully formulated (or target) composition. The masterbatch can include a carrier resin. The masterbatch is typically diluted with a letdown resin to form the target composition. The letdown resin may be the same or different polymer than the carrier resin. The masterbatch can be formed by dry mixing and/or melt blending the components.

The terms “olefin-based polymer” and “polyolefin” are used interchangeably. They refer to a polymer that contains more than 50 mole percent of a polymerized olefin monomer (based on total amount of polymerizable monomers), and optionally, may contain at least one comonomer. Examples of olefin-based polymers include an ethylene-based polymer, a propylene-based polymer, a butylene-based polymer, and polymers based on blends of the comonomers ethylene, propylene, butylene, hexene, and octene. Non-olefin monomers commonly found in copolymers with ethylene that would still be classified as an olefin-based polymer include acrylic acid, methacrylic acid, methyl acrylate, vinyl acetate and methyl methacrylate. Olefin-based polymers can be made using cyclic olefin monomers like norbornene.

The term “polymer” refers to a material prepared by reacting monomers together (“polymerizing”), whether of the same or a different type, which in polymerized form, provide the multiple and/or repeating “units” or “mer units” that make up a polymer. The term “polymer” thus embraces homopolymers (polymers prepared from only one type of monomer) and copolymers (polymers prepared from at least two types of monomers). The term also embraces all forms of copolymers, e.g., random, block, etc. A polymer is often referred to as being “made of” one or more specified monomers, “based on” a specified monomer or monomer type, “containing” a specified monomer content, or the like; in this context, the term “monomer” refers to the polymerized remnant or residue of the specified monomer and not to the unpolymerized species.

The term “propylene-based ionomer” refers to a propylene-based polymer that is an ionomer.

The terms “propylene-based polymer” and “polypropylene” refer to a polymer that contains more than 50 mole percent polymerized propylene monomer (based on the total amount of polymerizable monomers) and, optionally, may contain at least one comonomer. Propylene-based polymer includes propylene homopolymer, and propylene copolymer (meaning units derived from propylene and one or more comonomers).

The term “styrene-containing polymer” refers to a polymer that contains more than 20 mole percent of polymerized styrene monomer (based on the total amount of polymerizable monomers) and, optionally, may contain at least one comonomer. Styrene-containing polymer includes styrene homopolymer and styrene copolymer (meaning units derived from styrene and one or more comonomers). Examples of styrene-containing polymers include polystyrene, high impact polystyrene, styrene-butadiene copolymers, styrene-isoprene copolymers, acrylonitrile-butadiene-styrene copolymers, styrene-acrylonitrile polymers, styrene-acrylonitrile-maleic anhydride copolymers, styrene-maleic anhydride copolymers, styrene-maleimide copolymers, styrene-methyl methacrylate copolymers, acrylonitrile-styrene-acrylate copolymers, methacrylate-acrylonitrile-butadiene-styrene copolymers, and methyl methacrylate-butadiene-styrene copolymers. Styrene-containing polymers may also have olefins incorporated into the backbone. Variants of the constituent monomers of the polymers listed are included, such as alpha-methyl styrene in place of styrene as an example, acrylic or methacrylic acid monomers or their salts in the backbone or grafted onto the polymer, sulfonic acid or phosphonic acid or their salts grafted onto the polymer, or dicarboxylic acids, or their salts, and carboxylic anhydrides incorporated into the backbone or grafted onto the polymer.

### Aspects and Exemplary Embodiments

It has been surprisingly discovered that certain ionomers can effectively cavitate polyolefin continuous phases. Ionomers tend to resist deformation and breakup during processing, can reduce the density of polyolefin articles after orientation, and tend to be melt-process compatible with polyolefin continuous phases.

In particular, ionomers as cavitation agents can:
1. Lower cavitated film densities at colder extrusion temperatures, which improves blown-film bubble stability;
2. Lower cavitated film densities at higher orientation temperatures, which improves orientation stability of the film by minimizing the potential for breaks and holes in the film; and
3. Allow tailoring of elastic and interfacial tension properties, and hence improve voiding performance (i.e., density and opacity), using post-polymerization processes, rather than polymerizing new molecules.

### Composition

Thus, in one aspect, the present invention provides a composition comprising:
(A) a continuous polymeric phase comprising a polyolefin; and
(B) a cavitation agent dispersed in the continuous polymeric phase,
wherein the cavitation agent comprises one or more ionomers, and
wherein the one or more ionomers exclude ethylene-based ionomers and propylene-based ionomers.

The cavitation agent may be introduced into the continuous polyolefin phase to form the composition in various ways, such as
(A) via in situ ionomer formation inside the continuous polyolefin phase from
   a. Neutralization of an ionomer precursor, or
   b. Formation and neutralization of the ionomer precursor, or
   c. Direct formation of the ionomer through reaction with a neutralized monomer;
(B) by melt blending a non-diluted form of the cavitation agent containing the ionomer into the continuous polyolefin phase (direct addition);
(C) by melt blending a form of the cavitation agent containing the ionomer that has been diluted by a non-cavitation agent polymer into the continuous polyolefin phase (masterbatch addition); or
(D) by processing a blend that contains the cavitation agent (including the ionomer and non-ionomer components of the cavitation agent) at its final concentration level (i.e., fully diluted).

The composition may contain one or more conventional additives in traditional amounts. Examples of additives include heat stabilizers, light stabilizers, antioxidants, slip agents, anti-blocking agents, anti-static agents, flame retardants, pigments, dyes, processing aids, plasticizers, lubricants, and combinations thereof.

As noted, the composition may be prepared by any known method, such as melt blending. The components of the composition may be added simultaneously or sequentially into a melt blending device. Alternatively, the components may be dry mixed together to form a uniformly dispersed dry mixture, and the dry mixture may subsequently be introduced into a melt blending device. The melt blending device disperses the cavitation agent throughout the continuous polymeric phase. The blending may be carried out batch-wise or in a continuous mode. Examples of melt blending devices include a mixer/kneader, a Banbury mixer, a Farrel continuous mixer, a single-screw extruder, a twin-screw extruder, a roll mill, and combinations thereof. The melt blending procedure produces a composition with particles of the cavitation agent uniformly dispersed throughout the continuous polymeric phase.

In various embodiments, the composition may be a masterbatch. In the case of a masterbatch, the concentration of the cavitation agent may be in the range of 20 to 80 wt %, based on the total weight of the composition. Any and all ranges between 20 and 80 wt % are contemplated and disclosed herein, e.g., 30 to 70 wt % and 40 to 60 wt %.

In various other embodiments, the composition may be a target composition or a fully compounded or a fully formulated composition. Such compositions may be formed into an article without diluting with additional resins, e.g., a letdown resin. Fully formulated compositions may have a cavitation agent concentration in the range of 0.1 to 40 wt %, based on the total weight of the composition. Any and all ranges between 0.1 and 40 wt % are contemplated and disclosed herein, e.g., 1 to 35 wt %, 1 to 30 wt %, 1 to 20 wt %, and 1 to 15 wt %.

### Continuous Polymeric Phase

The continuous polymeric phase includes a polyolefin.

In various embodiments, the polyolefin comprises an ethylene-based polymer, a propylene-based polymer, or both.

Examples of ethylene-based polymers include ethylene homopolymer, ethylene/C₃-C₁₀ α-olefin copolymer (linear or branched), ethylene/C₄-C₈ α-olefin copolymer (linear or branched), high-density polyethylene (“HDPE”), low-density polyethylene (“LDPE”), linear low-density polyethylene (“LLDPE”), medium-density polyethylene (“MDPE”), ethylene-vinyl acetate copolymer (“EVA”), ethylene-methyl methacrylate copolymer (“EMA”), ethylene-acrylic acid copolymer (“EAA”), ethylene methacrylic acid copolymer (“EMAC”), neutralized copolymers of ethylene-acrylic acid copolymer or ethylene-methacrylic acid copolymer (“olefinic ionomers”), ethylene-norbornene copolymers (“COC”), ethylene-graft-maleic anhydride copolymers (“PE-g-MAH”), and combinations thereof. Examples of C₃-C₁₀ α-olefin comonomers include propylene, 1-butene, 1-hexene, 1-octene, and combinations thereof. Examples of C₄-C₈ α-olefin comonomers include 1-butene, 1-hexene, 1-octene, and combinations thereof.

Examples of propylene-based polymers include propylene homopolymer, propylene/ethylene copolymer, propylene/C₄-C₁₀ α-olefin copolymer, propylene impact copolymer, and combinations thereof. Examples of C₄-C₁₀ α-olefin comonomers include 1-butene, 1-hexene, 1-octene, and combinations thereof.

In various embodiments, the polyolefin is a carrier resin, a letdown resin, or both.

The carrier resin may be the same or different polymer as the letdown resin.

The amount of continuous polymeric phase in the composition can vary over a wide range. For example, the composition may contain from 60 to 99 wt % of the continuous polymeric phase. Any and all ranges between 60 and 99 wt % are contemplated and disclosed herein, e.g., 65 to 99 wt %, 70 to 99 wt %, and 80 to 99 wt %.

### Cavitation Agent

The cavitation agent is dispersed in the continuous polymeric phase.

The cavitation agent includes an ionomer, except for an ethylene-based ionomer and a propylene-based ionomer.

Examples of ionomers for cavitation include ionomers of ester-based polymers, ionomers of amide-based polymers, ionomers of styrene-containing polymers, ionomers of acrylic-containing polymers, ionomers of cellulosic-based polymers, ionomers of biodegradable polymers, and combinations thereof.

Ionomers of styrene-containing polymers can be synthesized from homopolymers or copolymers of polystyrenes through a variety of methods known in the industry. Similarly, for the polyesters, polyamides, acrylic polymers, cellulosics, and biodegradable polymers; these classes of polymer can be made into better cavitation agents through tailoring of their interfacial and rheological properties via ionomerization. In this regard, it has been surprisingly discovered that a polymer's cavitating ability in a polyolefin matrix can be vastly improved by modifying the polymer's interfacial tension with the matrix, the polymer's melt elasticity or elongational viscosity, and/or the polymer's melt viscosity-all of which may be achieved by converting the polymer into a corresponding ionomer.

As noted above, an ionomer includes an ionomer precursor and a cation component.

The ionomer may be prepared in various processing operations. One method is to combine the cation component (commonly as a metal hydroxide or as a metal salt) with an acid or anhydride copolymer in an extruder. The extruder can be nearly any commonly known in the industry, including: co-rotating twin-screw extruders; counter-rotating twin-screw extruders; single-screw extruders; and kneader extruders. The neutralization reaction can occur as an intermediate step or during the final extrusion operation. This method is sometimes referred to as plastic compounding where the individual components are melt processed in the compounder/extruder—the individual components being the ionomer precursor, the cation component, and optionally, a carrier resin. The residence time, temperature, and mixing intensity to ensure a complete reaction, and the possible need for devolatilization, may influence the selection and design of the extrusion operation. The ionomer may also be prepared in the solid state or in solution.

Another method is to graft a monomer that has already been neutralized with a cation component to a polymer to form the ionomer. Such monomers can include, for example, a metal or ammonium salt of an acrylic or methacrylic acid, amongst many other monomer types that exist or could be created for this purpose. This grafting can take place in any of the previously listed extruder types and may involve using additional components to enhance and/or terminate the grafting reaction, and it may occur during an intermediate production step or during the final extrusion step.

The ionomer can also be formed during copolymerization where the cation component is one of the comonomer species. The ionomer can also be formed in solution with appropriate solvents through neutralization of acid species with a cation component, grafting of an acid species onto the polymer followed by neutralization by a cation component, grafting of an already neutralized monomer species onto the polymer, or through any kind of coupling or chain transfer reactions to incorporate ionomeric repeating units, oligomers, or polymers into a separate polymer up to and including block copolymers. Examples of the last kind can be a transesterification of a polyester ionomer with a non-ionomer polyester, transamidation of a polyamide ionomer with a non-ionomer polyamide, or grafting of a carboxylate ionomer or polyelectrolyte onto a non-electrically active polymer.

In various embodiments, the non-olefinic ionomer may be formed in situ by incorporating one or more olefinic ionomers or polyelectrolytes with the ionomer precursor. The formation of the non-olefinic ionomer can be through transfer of cations from an olefinic ionomer or polyelectrolyte to a neutralizable non-olefinic ionomer precursor or through covalent bonding between the olefinic ionomer or polyelectrolyte and the non-olefinic ionomer precursor.

In various embodiments, the ionomer precursor may include a styrene-containing polymer, an ester-based polymer, an amide-based polymer, an acrylic-containing polymer, a cyclic olefin copolymer (COC), a non-olefinic biopolymer, a cellulosic polymer, or combinations thereof.

In various embodiments, the ionomer precursor comprises a styrene-containing polymer.

In various embodiments, the ionomer precursor comprises a styrene-maleic anhydride copolymer (SMA), a styrene-maleimide copolymer (SMI), a styrene-methyl methacrylate copolymer (SMMA), a styrene-acrylonitrile copolymer (SAN), a styrene-acrylonitrile-maleic anhydride copolymer (SAN-MAH), an acrylonitrile-styrene-acrylate copolymer (ASA), an acrylonitrile-butadiene-styrene copolymer (ABS), or combinations thereof.

In various embodiments, the ionomer precursor comprises SMA.

In various embodiments, the cation component may include zinc, sodium, calcium, lithium, magnesium, aluminum, ammonium, or combinations thereof.

In various embodiments, the cation component comprises sodium, such as sodium stearate.

In various embodiments, the cation component comprises aluminum, such as aluminum stearate.

In various embodiments, the cation component comprises zinc.

The zinc may be sourced from any suitable compound, such as from a zinc carboxylate salt, zinc sulfate, or a salt formed in situ from zinc oxide.

In various embodiments, the zinc source includes a zinc carboxylate salt. Examples of such salts include zinc acetate, zinc propanoate, zinc butanoate, zinc valerate, zinc caproate, zinc caprylate, zinc decanoate, zinc laurate, and zinc stearate.

In various embodiments, the ionomer comprises SMA, SMI, SMMA, SAN, SAN-MAH, ASA, ABS, or combinations thereof, and zinc ions.

In various embodiments, the ionomer comprises SMA and zinc ions.

In various embodiments, the ionomer comprises SMA, SMI, SMMA, SAN, SAN-MAH, ASA, ABS, or combinations thereof, and zinc stearate.

In various embodiments, the ionomer comprises SMA and zinc stearate.

In various embodiments, the ionomer comprises the reaction product of SMA and zinc stearate.

In various embodiments, the ionomer comprises zinc-neutralized styrene-maleic anhydride copolymer.

In various embodiments, the ionomer comprises sodium-neutralized styrene-maleic anhydride copolymer.

In various embodiments, the ionomer comprises a maleic anhydride grafted general purpose polystyrene (GPPS) that has been neutralized by zinc.

In various embodiments, the ionomer comprises a maleic anhydride grafted GPPS that has been neutralized by sodium.

In various embodiments, the ionomer comprises a maleic anhydride grafted acrylonitrile-butadiene-styrene copolymer (ABS) that has been neutralized by zinc.

In various embodiments, the ionomer comprises a maleic anhydride grafted ABS copolymer that has been neutralized by sodium.

In various embodiments, the ionomer comprises a methacrylic acid grafted ABS that has been neutralized by sodium.

In various embodiments, the ionomer comprises a methacrylic acid grafted ABS that has been neutralized by zinc.

In various embodiments, the ionomer comprises the reaction product of styrene-methyl methacrylate copolymer (SMMA), fumaric acid, and aluminum stearate.

In various embodiments, the ionomer comprises a fumaric acid grafted styrene acrylonitrile copolymer (SAN) that has been neutralized by sodium.

In various embodiments, the ionomer comprises a fumaric acid grafted SAN copolymer that has been neutralized by zinc.

In various embodiments, the ionomer comprises the reaction product of a fumaric acid grafted SAN and zinc stearate.

In various embodiments, the ionomer comprises SAN-MAH copolymer neutralized by zinc.

In various embodiments, the ionomer comprises styrene-maleic anhydride copolymer neutralized with a blend of sodium and zinc.

In various embodiments, the ionomer comprises the reaction product of styrene-maleic anhydride copolymer and a blend of sodium stearate and zinc stearate.

In various embodiments, the ionomer comprises the reaction product of styrene-maleic anhydride copolymer and zinc oleate.

In various embodiments, the ionomer comprises the reaction product of styrene-maleic anhydride copolymer and zinc erucate.

In various embodiments, the ionomer comprises a fumaric acid grafted GPPS neutralized with zinc.

In various embodiments, the ionomer comprises the reaction product of a fumaric acid grafted GPPS and zinc stearate.

In various embodiments, the ionomer has a molar ratio of acid equivalents to monomer units of 0.1% to 100%, and a neutralization of acid equivalents of 0.5% to 100%.

In various embodiments, the cavitation agent comprises only ionomers.

In various other embodiments, the cavitation agent further includes a non-ionomeric polymer.

The non-ionomeric polymer may include a styrene-containing polymer, a polyester, a polyamide, a thermoplastic polyurethane, or combinations thereof.

Examples of non-ionomeric polymers include a styrene-containing polymer, an ester-based polymer, an amide-based polymer, an acrylic-containing polymer, a cyclic olefin copolymer (COC), a non-olefinic biopolymer, a cellulosic polymer, or combinations thereof.

If a non-ionomeric polymer is included, the cavitation agent may have a weight ratio of ionomer to non-ionomeric polymer of 1:99 to 99:1. Any and all ranges between 1:99 and 99:1 are contemplated and disclosed herein, e.g., 5:95 to 95:5 and 10:90 to 90:10.

The amount of cavitation agent in the composition can vary over a wide range. For example, the composition may contain from 0.1 to 40 wt % of the cavitation agent. Any and all ranges between 0.1 and 40 wt % are contemplated and disclosed herein, e.g., 0.1 to 40 wt %, 0.1 to 30 wt %, 1 to 30 wt %, 1 to 20 wt %, and 1 to 15 wt %.

Polymers are held together by attractive forces acting upon their constituent molecules. At the interface between two immiscible polymers, an interfacial tension arises due to the disparity between the attractive forces within each of the polymers, reflecting differences in polarity and other factors that affect compatibility and adhesion. This results in the formation of droplets or inclusions of the cavitation agent within the matrix polymer when they are blended. Therefore, interfacial tension is a measure of incompatibility between polymers. The more alike the polymeric materials are, the lower the interfacial tension and the smaller the driving force holding the droplet (cavitation agent) together, and the smaller the droplet size. Taking this to the extreme, if the two materials are miscible (and therefore have an interfacial tension of zero), then no inclusions form.

Interfacial tension can be calculated using the method outlined in the Examples section. Measurements used for the calculation are based on a 20-wt % loading of the ionomer cavitation agent in the composition using a parallel plate rheometer.

In various embodiments, the interfacial tension between the continuous polymeric phase and the ionomer component of the cavitation agent may be from 0.1 to 20 mN/m at 190° C. Any and all ranges between 0.1 and 20 mN/m are contemplated and disclosed herein, e.g., from 1.5 to 20 mN/m, from 3 to 20 mN/m, from 6 to 20 mN/m, and from 9 to 20 mN/m.

In various other embodiments, the interfacial tension between the continuous polymeric phase and the ionomer component of the cavitation agent is at least 0.5 mN/m at 190° C.

In various other embodiments, the ratio of interfacial tension of the ionomer to the interfacial tension of the non-ionomer equivalent polymer is greater than 1.1

The cavitation agent may be characterized by an aspect ratio. The aspect ratio is the ratio of an inclusion's major axis diameter divided by the inclusion's minor axis diameter. For a sphere, the aspect ratio is one, and for an ellipsoid, the aspect ratio is greater than one. For films oriented in the direction of the major axis of the cavitation agent, cavitation agents with aspect ratios closer to 1 prior to orientation will result in more efficient cavitation, i.e., lower cavitated article densities. A method for measuring the aspect ratio can be found in the Analytical Methods section.

In various embodiments, the cavitation agent comprises at least one ionomer having an average inclusion aspect ratio from 1 to 5, from 1 to 4, from 1 to 3, or from 1 to 2, before or after orientation or both, as measured according to the method described in the Analytical Methods section.

In various embodiments, the cavitation agent comprises at least one iomomer having an elongational viscosity ranging from 10 to 100,000 Pas at any elongation rate from 100 to 500 s⁻¹, where the elongational viscosity is measured using the Cogswell method at 190° C. or greater. Any and all ranges between 10 to 100,000 Pa·s are contemplated and disclosed herein, e.g., from 100 to 50,000 Pa·s, from 500 to 50,000 Pa·s, from 200 to 25,000 Pas, from 500 to 25,000 Pa·s, from 500 to 20,000 Pa·s, from 1,000 to 20,000 Pa·s, from 500 to 15,000 Pa·s, and from 2,000 to 15,000 Pa·s. The higher the elongational viscosity, the less likely the cavitation agent is to elongate, and the closer the aspect ratio of the cavitation agent inclusions will be to one.

In various embodiments, the ionomer component of the cavitation agent can be more elastic than the continuous polymeric phase, such that the elasticity ratio of the ionomer component of the cavitation agent to the continuous polymeric phase when measured at 0.1 radians/second can range from 0.1 to 50, from 0.5 to 40, or from 1.0 to 25 at 230° C.; or from 1.0 to 700, from 25 to 650, or from 50 to 650 at 200° C.

In various other embodiments, the elasticity ratio of the ionomer component of the cavitation agent to the continuous polymeric phase ranges from 10 to 1,000, from 10 to 700, or from 20 to 700 at 200° C., when measured at 0.1 rad/s.

In various embodiments, the ionomer component of the cavitation agent can be less viscous than the continuous polymeric phase at typical extrusion conditions, such that the viscosity ratio of the ionomer component of the cavitation agent to the continuous polymeric phase when measured at 100 radians/second can range from 0.01 to 1.3, from 0.1 to 0.50, or from 0.1 to 0.20 at 230° C.; or from 0.10 to 1.3, from 0.2 to 0.8, or from 0.3 to 0.5 at 200° C.

In various other embodiments, the viscosity ratio of the ionomer component of the cavitation agent to the continuous polymeric phase ranges from 0.10 to 100, from 0.1 to 50, from 0.1 to 25, or from 0.25 to 20 at 200° C., when measured at 100 rad/s.

In various embodiments, the tensile modulus of the cavitation agent is at least 10% higher than the tensile modulus of the continuous polymeric phase when the tensile modulus of the cavitation agent is measured at the Vicat softening temperature of the continuous polymeric phase. Preferably, the tensile modulus of the cavitation agent is 10% to 10,000% higher than the tensile modulus of the continuous polymeric phase. More preferably, the tensile modulus of the cavitation agent is 20% to 5,000% higher than the tensile modulus of the continuous polymeric phase.

In various embodiments, the surface energy of the ionomer differs from the surface energy of the continuous polymeric phase by 0 dynes/cm or greater, by 2 dynes/cm or greater, or by 5 dynes/cm or greater.

In various embodiments, the ionomer cavitation agent has a shear rheology behavior that is different from the ionomer precursor of the ionomer. The elastic modulus (G′), dynamic modulus (G″), and/or viscosity of the ionomer cavitation agent would be higher as compared to the ionomer precursor's properties when measured using the same sample preparation and test method. The ionomer cavitation agent generally resists deformation caused by the continuous polymeric phase during the extrusion and orientation process because of the rheological difference.

In various embodiments, the ionomer cavitation agent has a lower melt flow rate (MFR) as compared to the ionomer precursor. A cavitation agent with a lower MFR generally resists deformation caused by the continuous polymeric phase.

In various embodiments, the ionomer cavitation agent has an MFR of 0.1 to 35 g/10 minutes, from 0.1 to 20 g/10 minutes, from 0.1 to 15 g/10 minutes, or from 0.1 to 10 g/10 minutes, when measured according to ASTM D1238 at 230° C. with a 2.1 kg weight.

### Cavitated Article

The composition of the invention is particularly suitable for making cavitated articles.

Thus, in a second aspect, the invention provides a cavitated article comprising the composition of the invention.

Examples of cavitated articles include films, sheets, fibers, and tubes.

The cavitated article may be monolayer or multilayer.

The cavitated article can be used to create a range of products, such as bags (including woven bags), labels (including shrink labels), shrink films, laminates, standup pouches, wraps, straps, ribbons, strips, tapes, lids, trays, bowls, cups, bottles, yarns, fabrics (including woven raffia fabrics), and clothing.

In various embodiments, the cavitated article is a film. The cavitated film can be used to make laminated structures. For example, a cavitated film can be laminated on one or both sides to another material, such as a polymer or a metal, to form a laminate.

The cavitated film can also be used to make packaging materials, such as standup pouches, bags, woven bags, woven raffia fabrics, labels (e.g., shrink labels), shrink films, laminates, wraps, straps, ribbons, strips of film, tapes, lids, trays, bowls, cups, and bottles.

In various embodiments, the cavitated article is a sheet. The cavitated sheet can be thermoformed, for example, to make products, such as lids, bowls, and cups.

In various embodiments, the cavitated article is a fiber. The cavitated fiber can be used to make products, such as yarns, fabrics, and clothing.

### Method of Making Cavitated Article

In a third aspect, the invention provides a method of making a cavitated article.

In various embodiments, the method includes the steps of:
(a) forming a melt comprising the composition of the invention;
(b) forming an article from the melt;
(c) cooling the article; and
(d) stretching the cooled article in at least one direction to form the cavitated article.

In various other embodiments, the method includes the steps of:
(a) forming a melt comprising the composition of the invention;
(b) forming an article from the melt;
(c) cooling the article, and optionally heating the article, to an orientation temperature;
(d) orienting the article from step (c) in at least one direction to form a cavitated article; and
(e) optionally, (i) annealing the cavitated article at a temperature higher than the orientation temperature, (ii) allowing the cavitated article to contract in the direction of orientation, or both (i) and (ii); or
(f) optionally, (i) annealing the cavitated article at or below the orientation temperature to retain a desired shrink in the article, (ii) allowing the cavitated article to contract in the direction of orientation, or both (i) and (ii).

In the above methods, the article may be a film, a sheet, a fiber, or a tube.

A melt comprising the composition of the invention may be formed in any known matter. For example, the cavitation agent may be heated in an extruder where it may be melt blended with a letdown resin and additive(s).

The melt may then be formed into an article by any known technique, such as an extrusion process where the molten mixture is forced into a die (typically, a metal structure with cutouts or holes), which shapes the mixture into an article that hardens during cooling.

Cooling may be carried out by any known manner, e.g., by contacting the article with cooled surfaces or with a cooling fluid, such as air and/or in a liquid bath.

The cooled article is then subjected to an orientation procedure (otherwise known as a drawing procedure or a stretching procedure) to form a cavitated or oriented article. Examples of stretching procedures include aspiration (e.g., fiber draw units), tensile frame drawing, machine direction orienting (MDO), tenter frame for transverse drawing, biaxial drawing, multi-axial drawing, profile drawing, vacuum drawing, double-bubble/triple bubble orientation, and combinations thereof.

The cooled article is usually stretched at a temperature less than the melting point of the continuous polymeric phase to form a cavitated article. In the case of an ethylene-based polymer matrix, stretching temperatures are typically 50° C. or greater, 60° C. or greater, or 70° C. or greater; and in each case, up to 10° C. less than the melting point of the continuous polymeric phase. In the case of a propylene-based polymer matrix, stretching temperatures are typically 70° C. or greater, 90° C. or greater, or 110° C. or greater; and in each case, up to 10° C. less than the melting point of the continuous polymeric phase.

The cooled article may be stretched, for example, from 2 to 10 times its original dimension, in either the machine direction, the transverse direction, or both. Any and all stretch ratios between 2 and 10 are contemplated and disclosed herein, e.g., 3×, 4×, 5×, and 6×.

The stretching procedure produces voids or cavities around particles of the cavitation agent in the continuous polymeric phase of the resulting article. For a uniaxially stretched or oriented article, the cavities may have a major axis with an average length of 0.8 microns to 24 microns and a minor axis with an average length of 0.2 microns to 10.0 microns.

Annealing is the process of holding an article (typically a film) at an elevated temperature to relieve internal stresses and, optionally, allowing it to retract at the annealing temperature to enhance the stress relief. In MDO, the film article builds internal stresses as it is drawn progressively through the rollers. After stretching, the film article progresses across one or more annealing rollers. Typically, the film article is annealed by heating above the stretching temperature and allowing the film article to contract. In TDO and biaxial stretching, similar techniques can be used to anneal the film articles.

### General Provisions

To remove any doubt, the present invention includes and expressly contemplates and discloses any and all combinations of embodiments, features, characteristics, parameters, and/or ranges mentioned herein. That is, the subject matter of the present invention may be defined by any combination of embodiments, features, characteristics, parameters, and/or ranges mentioned herein.

It is contemplated that any ingredient, component, or step that is not specifically named or identified as part of the present invention may be explicitly excluded.

Any process/method, apparatus, compound, composition, embodiment, or component of the present invention may be modified by the transitional terms “comprising,” “consisting essentially of,” or “consisting of,” or variations of those terms.

While attempts have been made to be precise, the numerical values and ranges described herein may be considered approximations. These values and ranges may vary from their stated numbers depending upon the desired properties sought to be obtained by the present disclosure as well as the variations resulting from the standard deviation found in the measuring techniques. Moreover, the ranges described herein are intended and specifically contemplated to include all sub-ranges and values within the stated ranges. For example, a range of 50 to 100 is intended to include all values within the range including sub-ranges such as 60 to 90, 70 to 80, etc.

Any two numbers of the same property or parameter reported in the working examples may define a range. Those numbers may be rounded off to the nearest thousandth, hundredth, tenth, whole number, ten, hundred, or thousand to define the range.

The content of all documents cited herein, including patents as well as non-patent literature, is hereby incorporated by reference in their entirety. To the extent that any incorporated subject matter contradicts with any disclosure herein, the disclosure herein shall take precedence over the incorporated content.

Unless stated to the contrary, implicit from the context, or customary in the art; all parts and percentages are based on weight and all test methods are current as of the filing date of this specification.

This invention can be further illustrated by the following working examples, although these examples are included merely for purposes of illustration and are not intended to limit the scope of the invention.

### EXAMPLES

### Analytical Methods

The aspect ratio is the ratio is the major axis divided by the minor axis. The major axis diameter refers to the major axis of the inclusion when viewed in the plane of the machine direction (when the inclusion is not spherical). The minor axis diameter refers to the minor axis of the inclusion when viewed in the plane of the machine direction (when the inclusion is not spherical). Scanning electron micrograph (SEM) images can be used to quantify the number average cross-sectional diameter of the cavitation agent in the article. SEM images of the cross-sections of the article, formed by (i) extrusion only or (ii) extrusion and Machine Direction Orientation (MDO), at a magnification of 3000×(Coxem EM30N) to 4,000×(JEOLJSM-6500F Field Emission Gun Scaning Electron Microscope (FEG-SEM)) can be used for analysis. Each inclusion can be measured at the widest point in the cross-section to determine the major axis diameter. The minor axis measurement is perpendicular to the major axis measurement and is measured at the mid-point of the major axis. The software tool uScope Essentials from PixeLINK can be used in the particle analysis. A reference marker on the images can be used for distance calibration.

The average inclusion aspect ratio is determined by measuring the aspect ratio of all inclusions (minimum of 25) within a randomly selected square or rectangular window or windows which span across the cavitation layer thickness, and dividing the sum of those ratios by the number of inclusions measured. In the case of multiple windows, their combined widths should be large enough to include the minimum number of inclusions. The selection of the windows should be such that the inclusions are a representative sampling of all inclusions within the specimen.

Viscosity ratio is the complex viscosity of the cavitation agent polymer divided by the continuous polymeric phase viscosity, where the viscosity for both polymers are at the same experimental setup and test conditions. The ratio must be calculated for viscosities at the same test temperature and frequency. The individual viscosity data is obtained from DMA dynamic parallel plate rheology measuring under ASTM D4440. A frequency of 100 s⁻¹ is chosen to represent the shear rate typically found in an extrusion process.

Elasticity ratio is the elastic storage modulus (G′) of the cavitation agent polymer divided by the continuous polymeric phase elastic storage modulus, where the elastic storage modulus for both polymers are at the same experimental setup and test conditions. The ratio must be calculated using data collected at the same test temperature and frequency, where the elastic storage modulus is typically measured at very low frequency rates. Generally, the low frequency is at 0.1 radians/second, more preferably, near 0.01 radians/second, depending on the experimental setup. The individual storage modulus (G′) data is obtained from DMA dynamic parallel plate rheology measuring under ASTM D4440.

A procedure was developed for measuring the interfacial tension between a single cavitation agent type that is not carried in another polymer and the continuous polymeric phase resin (for reference, see Graebling, D., Muller, R. and Palierne, J. F., 1993, “Linear viscoelastic behavior of some incompatible polymer blends in the met. This procedure is intended for measuring the pure cavitation agent (not carried) and is not intended to measure the interfacial tension for blends of different cavitation agents. Interpretation of data with a model of emulsion of viscoelastic liquids,” Macromolecules, 26, 320-329):
1. Measure the complex viscosity (ASTM D4440) of the continuous polymeric phase resin as a function of frequency at the temperature of the interfacial tension measurement. The continuous polymeric phase resin should be of the same polyolefin family as the continuous polymeric phase used in the cavitated article. For polyethylene, the temperature range should be 180° C. to 200° C. For polypropylene, the temperature range should be 210° C. to 230° C. Estimate the zero-shear viscosity of the continuous polymeric phase from a plot of complex viscosity versus frequency (frequency in rad/s is equivalent to shear rate in s⁻¹ via the Cox-Merz Rule).
2. Measure the complex viscosity of the cavitation agent (inclusion polymer) at the temperature of the interfacial tension measurement as a function of frequency and estimate the zero-shear viscosity. The measurement of the cavitation agent should be at the same conditions as Step 1 for the continuous polymeric phase.
3. Calculate the viscosity ratio K (zero-shear viscosity of the cavitation agent/zero-shear viscosity of the continuous polymeric phase).
4. Make a blend of the cavitation agent and continuous polymeric phase. The loading level of the cavitation agent should be enough to determine the deviation from linearity in the storage modulus (G′), generally a 20-30% loading by weight, but not too high that the cavitation agent is no longer the discrete phase. Measure storage modulus (G′) versus frequency (rad/s) of the blend and plot on a log-log scale. In the limit of small frequencies, the G′ versus frequency plot for a pure polymer is linear. For immiscible polymer blends, a deviation from linearity occurs due to the relaxation of the dispersed domain. This relaxation has a characteristic relaxation time (λ_{D}) that is the inverse of the frequency (rad/s) where the shoulder of the deviation ends.
5. Measure the cavitation agent particle size (diameter) in the blend. If there is a range of particle sizes, compute an average diameter.
6. Calculate the interfacial tension using equations (1) and (2):

$$\\ \begin{matrix}H = \frac{( 19 K + 16 ) ( 2 K + 3 - 2 ⌀ ( K - 1 )}{10 ( K + 1 ) - 2 ⌀ ( 5 K + 2 )} & ( 1 )\end{matrix}$$

$$\\ \begin{matrix}{Γ}_{12} = \frac{D {η}_{m}}{8 {λ}_{D}} H . & ( 2 )\end{matrix}$$

In equations (1) and (2), Γ₁₂ is the interfacial tension, K is the viscosity ratio, Ø is the volume fraction of the cavitation agent in the blend, D is the volume-average cavitation agent particle diameter in the blend, ηₘ is the matrix (continuous polymeric phase) zero-shear viscosity, and λ_{D} is the blend relaxation time found in step 4.

The Cogswell elongational viscosity is a capillary rheology measurement method using an orifice die (zero L/D) according to ASTM D3835. The entrance losses are available directly from these measurements. Measurements are also made with a long die (20 L/D). Barrel diameters of 12 mm with die entry angle of 180° and 1 mm die diameter are used. Die lengths are 0.3 mm and 20 mm. The samples are typically undried; however, hydrophilic resins should be dried prior to testing. The sample is loaded into pre-heated test barrels of the capillary rheometer. A range of flow rates are run, resulting in a shear rate range of 10-10,000/s at 230° C. Pressure drop across the die is measured for each flow rate, and viscosity-shear rate data are calculated. Rabinowitsch and Bagley corrections are performed. Using Cogswell's equations, the elongational viscosity versus elongation rate is calculated.

$$\\ Shear Rate {\dot{γ}}_{a} = \frac{32 Q}{π {D}^{{}_{} 3}}$$

$$\\ Shear Stress ( Bagley corrected ) {τ}_{w} = \frac{Δ P}{4 L} D$$

$$\\ Shear Viscosity η = \frac{{τ}_{w}}{{\dot{γ}}_{a}}$$

$$\\ Rabinowitsch Correction \dot{γ} = \frac{( 3 n + 1 )}{4 n} {\dot{γ}}_{a}$$

$$\\ Cogswell Elongational Viscosity λ = \frac{9}{32} \frac{{( n + 1 )}^{2}}{η} {( \frac{{P}_{o}}{\dot{γ}} )}^{2}$$

$$\\ Cogswell Elongational Stress {σ}_{E} = \frac{3}{8} ( n + 1 ) {P}_{o}$$

$$\\ Cogswell Elongation Rate τ = \frac{{σ}_{E}}{λ}$$

where:
\dot{γ}=true shear rate;

$$\\ {\dot{γ}}_{a} = apparent shear rate = \frac{4 Q}{π {R}^{{}_{} 3}} = \frac{4 V}{π {R}^{{}_{} 3} t} ;$$

n=exponent of the power law fit of the shear stress-shear rate log-log plot;
Q=volumetric flow rate;
ΔP=pressure difference between the long die pressure drop and the orifice L/D die pressure drop;
Pₒ=orifice die pressure drop;
t=extrudate collection time;
V=extrudate volume;
D=diameter of capillary;
R=radius of capillary; and
L=capillary length.

Density for films was determined using an analytical balance to measure the mass of a film to the ten-thousandth of a gram (g) and a pycnometer (Accupyc 1340, Micromeritics Norcross, Ga.) to measure the volume of the sample to the ten-thousandth of a cubic centimeter (cm³). The pycnometer used sulfur hexafluoride gas as the medium to determine volume. Density was determined by the pycnometer software where film mass was divided by film volume, with results reported in g/cm³.

Density for polymers was measured in accordance with ASTM D792. The result is recorded in grams per cubic centimeter (g/cm³).

Glass transition temperature (Tg) was measured in accordance with ASTM D3418 with results reported in degrees Celsius (C).

Optical density was measured using an X-rite 331C Transmission Densitometer and used to calculate film opacity using the following formula:

$$\\ opacity = 100 - {10}^{{}_{} ( 2 - optical density )}$$

with results reported in percent (%).

Melt flow index (MFI) for ethylene-based polymers was measured according to ASTM D1238, Condition 190° C./2.16 kg, with results reported in grams per 10 minutes (g/10 min).

Melt flow rate (MFR) for non-ethylene based polymers was also measured according to ASTM D1238, but at varied conditions. The results are reported in grams per 10 minutes (g/10 min).

Tensile modulus and tensile yield stress were measured according to ASTM D882, with results reported in megaPascals (MPa).

### Experimental Procedures

Unless otherwise noted, the ionomeric cavitation agents were prepared by feeding the individual components into the feed-throat of a Coperion twin-screw extruder line to form the ionomer. If a masterbatch was formed, then the ionomer components (cavitation agent polymer and metal salt) were blended with a polyethylene carrier in the Coperion twin-screw extruder. The individual components included styrene-maleic anhydride copolymer (SMA), zinc stearate, and a linear low-density polyethylene (LLDPE) as the carrier resin, unless noted otherwise.

Cavitated films were prepared using a three-layer LabTech blown-film line with a 120-mm die. The die was fed by two 30-mm screws with an L/D ratio of 30:1 for the skin layers and one 45-mm screw with an L/D ratio of 33:1 for the core layer. The films were stretched on an inline MDO made by LabTech.

### Materials

The materials used in the examples are set forth in Table 1 below.

TABLE 1

| Material | Use | Description |
|---|---|---|
| mLLPDE 1 | Carrier | mLLDPE, density = 0.912 g/cm³, melt flow index = 1.0 g/10 min |
| mLLDPE 2 | Matrix & Skin | mLLDPE, density = 0.918 g/cm³, melt flow index = 1.0 g/10 min |
| mLLDPE 3 | Matrix | mLLDPE, density = 0.927 g/cm³, melt flow index = 1.3 g/10 min |
| mLLDPE 4 | Carrier | mLLDPE, density = 0.918 g/cm³, melt flow index = 3.5 g/10 min |
| mLLDPE 5 | Carrier | mLLDPE, density = 0.918 g/cm³, melt flow index = 4.5 g/10 min |
| mLLDPE 6 | Carrier | mLLDPE, density = 0.918 g/cm³, melt flow index = 2.0 g/10 min |
| Z-N LLDPE 1 | Matrix | Z-N LLDPE, density = 0.917 g/cm³, melt flow index = 2.3 g/10 min |
| MDPE 1 | Skin/Matrix | MDPE, density = 0.94 g/cm³, melt flow index = 0.85 g/10 min |
| HDPE 1 | Matrix | HDPE, density = 0.95 g/cm³, melt flow index = 1.5 g/10 min |
| SMA 1 | Cavitating | Styrene-maleic anhydride copolymer, Tg = 120° C. 16.9% |
| | Agent | molar ratio of acid equivalents. |
| SMA 2 | Cavitating | Styrene-maleic anhydride copolymer, Tg = 130° C. 29.5% |
| | Agent | molar ratio of acid equivalents. |
| SMA 1 | Cavitating | SMA 1 with zinc stearate |
| Ionomer | Agent | |
| SMA 2 | Cavitating | SMA 2 with zinc stearate |
| Ionomer | Agent | |
| SMA 1 + | Cavitating | SMA 1 with stearic acid |
| SA | Agent | |
| SAN-MAH | Cavitating | Styrene-Acrylonitrile-Maleic anhydride copolymer, Tg >90° C. |
| | Agent | 8% by weight of maleic anhydride content |
| SAN-MAH | Cavitating | SAN-MAH with zinc stearate |
| Ionomer | Agent | |
| PETG | Cavitating | Poly(ethylene terephthalate) glycol-modified |
| | Agent | |
| GPPS | Cavitating | General purpose polystyrene |
| | Agent | |
| PP | Cavitating | Polypropylene homopolymer, density = 0.900 g/cm³, |
| | Agent | MFR = 1.8 g/10 min (230° C./2.16 kg) |
| PP Ionomer | Cavitating | PP with zinc acrylate |
| | Agent | |

Some properties of the cavitation agent materials were measured and reported in Tables 2 and 3 below. The melt viscosity and elasticity ratio for the SMA 1 and SMA 2 ionomers were measured on ionomers containing a 34:1 weight ratio of polymer to zinc stearate. For SMA 1 and SMA 2 ionomers, a 34:1 polymer to zinc stearate ratio corresponds to a 5.7 mole % and a 3.3 mole % neutralization, respectively. The remaining properties for the SMA 1 and SMA 2 ionomers were measured for ionomers containing a 24:1 weight ratio of polymer to zinc stearate. For SMA 1 and SMA 2 ionomers, a 24:1 polymer to zinc stearate ratio corresponds to an 8.1 mole % and a 4.6 mole % neutralization, respectively. For the PP Ionomer in Table 3, the neutralization level was 100%, and the molar ratio of acid equivalents was near 1%. All of the ionomers in this example did not have a carrier resin. The ionomers were produced using the melt blending experimental method, without the carrier resin.

TABLE 2

| | Cavitation Agents | | | | |
|---|---|---|---|---|---|
| | | | SMA 1 | SMA 2 | SMA 1 + |
| Property | SMA 1* | SMA 2* | Ionomer | Ionomer | SA* |
| Tensile Modulus at | >1** | >1** | >1** | >1** | >1** |
| Ambient Temp. | | | | | |
| (GPa) | | | | | |
| Surface Energy | 54-56 | 56-58 | 42 | 36 | 62 |
| (dynes/cm) | | | | | |
| Surface Energy | 25 | 27 | 12 | 6 | 32 |
| Difference vs. mLLDPE | | | | | |
| 2 (dynes/cm) | | | | | |
| Melt Viscosity Ratio of | 1.2 | 3.5 | 1.4 | 3.7 | — |
| Mat'l to mLLDPE 2 at | | | | | |
| 200° C. and 1 rad/s | | | | | |
| Melt Viscosity Ratio of | 1.8 | 6.0 | 2.5 | 11.6 | — |
| Mat'l to mLLDPE 2 at | | | | | |
| 200° C. and 0.01 rad/s | | | | | |
| Melt Viscosity Ratio of | 0.35 | 0.54 | 0.32 | 0.46 | — |
| Mat'l to mLLDPE 2 at | | | | | |
| 200° C. and 100 rad/s | | | | | |
| Melt Elasticity Ratio of | 24 | 142 | 63 | 630 | — |
| Mat'l to mLLDPE 2 at | | | | | |
| 200° C. and 0.1 rad/s | | | | | |
| Melt Elasticity Ratio of | 0.4 | 1.1 | 1 | 24 | — |
| Mat'l to mLLDPE 2 at | | | | | |
| 230° C. and 0.1 rad/s | | | | | |
| Cavitated m-LLDPE | Yes | Yes | Yes | Yes | Yes |

*=Comparative
**=Data obtained from literature.

TABLE 3

| | Cavitation Agents | | | |
|---|---|---|---|---|
| | | | | PP |
| Property | PETG* | GPPS* | PP* | Ionomer* |
| Tensile Modulus at | >1** | 3.17 | 0.57 @ | 0.56 @ |
| Ambient Temp. | | | 75° C. | 75° C |
| (GPa) | | | | |
| Surface Energy | 54 | 36 | <30 | 32 |
| (dynes/cm) | | | | |
| Surface Energy | 24 | 6 | 0 | 2 |
| Difference vs. | | | | |
| mLLDPE 2 (dynes/cm) | | | | |
| Melt Viscosity Ratio of | 0.86 | — | — | — |
| Mat'l to mLLDPE 2 at | | | | |
| 200° C. and 1 rad/s | | | | |
| Melt Viscosity Ratio of | 0.93 | — | — | — |
| Mat'l to mLLDPE 2 at | | | | |
| 200° C. and 0.01 rad/s | | | | |
| Melt Viscosity Ratio of | 0.94 | — | — | — |
| Mat'l to mLLDPE 2 at | | | | |
| 200° C. and 100 rad/s | | | | |
| Melt Elasticity Ratio of | 15 | — | — | — |
| Mat'l to mLLDPE 2 at | | | | |
| 200° C. and 0.1 rad/s | | | | |
| Melt Elasticity Ratio of | 3.4 | — | — | — |
| Mat'l to mLLDPE 2 at | | | | |
| 230° C. and 0.1 rad/s | | | | |
| Melt Interfacial | — | — | — | — |
| Tension (mN/m) | | | | |
| Melt Flow Rate | 5.4 | 2.2 | 1.5 | 0.75 |
| (230° C./2.1 kg) | | | | |
| (g/10 min) | | | | |
| Cavitated mLLDPE | Yes | Yes | — | No |

*= Comparative
**= Data obtained from literature.

### Example 1

Three-layer films were produced on a LabTech blown-film line with a die diameter of 120 mm, at 35 kg/hr throughput, an extrusion temperature of 190° C., and a 15/70/15 layer ratio by volume. The skin layers contained MDPE 1, and the core layer was loaded with 15% by weight of a cavitation masterbatch letdown with mLLDPE 3.

Each masterbatch contained 60% by weight of cavitation agent and 40% by weight of mLLDPE 1 as a carrier resin. The cavitation agent was SMA 1 and zinc stearate blended at a 60:1 weight ratio (3.2 mole % neutralized) of SMA 1 to zinc stearate. Additional cavitation masterbatches were made at a 40:1 weight ratio (4.8 mole % neutralized) and at a 24:1 weight ratio (8.1 mole % neutralized) of SMA 1 to zinc stearate. A control of SMA 1 without zinc stearate was blended with mLLDPE 1 carrier resin to form a non-ionomer masterbatch.

The films were stretched 5×using machine direction orientation (MDO) at 65° C. and 75° C., and annealed at 110° C., relaxing the film 27.8%.

The density and opacity of the resulting films were measured and reported in Table 4.

TABLE 4

| | Cavitation Agents | | | | | | | |
|---|---|---|---|---|---|---|---|---|
| | | SMA 1 + | SMA 1 + | SMA 1 + | | SMA 1 + | SMA 1 + | SMA 1 + |
| | | 60:1 | 40:1 | 24:1 | | 60:1 | 40:1 | 24:1 |
| | | zinc | zinc | zinc | | zinc | zinc | zinc |
| | SMA 1* | stearate | stearate | stearate | SMA 1* | stearate | stearate | stearate |
| MDO | 65 | 65 | 65 | 65 | 75 | 75 | 75 | 75 |
| Stretch | | | | | | | | |
| Temp. | | | | | | | | |
| (° C.) | | | | | | | | |
| Film | 33 | 32 | 37 | 38 | N/A | 35 | 34 | 34 |
| Gauge | | | | | | | | |
| (μm) | | | | | | | | |
| Film | 0.866 | 0.851 | 0.811 | 0.808 | N/A | 0.860 | 0.825 | 0.795 |
| Density | | | | | | | | |
| (g/cm³) | | | | | | | | |
| Film | 45.9 | 40.1 | 43.3 | 34.4 | N/A | 44.2 | 33.9 | 36.9 |
| Opacity | | | | | | | | |
| (%) | | | | | | | | |

*= Comparative

As seen from Table 4, the film density decreased with increasing zinc stearate loading, and the opacity generally decreased.

### Example 2

Three-layer films were prepared as described in Example 1, except as noted below.

Each masterbatch contained 60% by weight of cavitation agent and 40% by weight of mLLDPE 1 as a carrier resin. The cavitation agents were (1) neat SMA 1; (2) neat SMA 2; (3) SMA 1 ionomer with a 24:1 weight ratio of SMA 1 to zinc stearate (8.1 mole % neutralized); and (4) SMA 2 ionomer with a 24:1 weight ratio of SMA 2 to zinc stearate (4.6 mole % neutralized).

The films were extruded at three different extrusion temperatures, with the barrel and die temperatures set to 200° C., 215° C., and 230° C. to show the impacts of the ionomer on final film density across increasing extrusion temperatures that are relevant to blown film extrusion. The films were stretched 4.5×using machine direction orientation (MDO) at 70° C. and annealed at 110° C., relaxing the film 27.8%.

Film densities were measured and are reported in Table 5.

TABLE 5

| | Film Density after 4.5X Stretch | | | |
|---|---|---|---|---|
| Extruder | (g/cm³) | | | |
| & Die | | SMA 1 + 24:1 | | SMA 2 + 24:1 |
| Temperatures | SMA 1* | zinc stearate | SMA 2* | zinc stearate |
| 200° C. | 0.895 | 0.839 | 0.886 | 0.832 |
| 215° C. | 0.886 | 0.835 | 0.894 | 0.837 |
| 230° C. | 0.877 | 0.837 | 0.879 | 0.840 |

*= comparative

### Example 3

Various cavitation agents were prepared in a Coperion ZSK-26 compounder at 18 kg/hr throughput and 220° C. extrusion temperature for melt flow rate (MFR) comparison, without the carrier resin. The following cavitation agents were produced:
(1) SMA 1;
(2) SMA 1 with zinc stearate at a 120:1 weight ratio (1.6 mole % neutralized) of SMA 1 to zinc stearate;
(3) SMA 1 with zinc stearate at a 60:1 weight ratio (3.2 mole % neutralized) of SMA 1 to zinc stearate;
(4) SMA 1 with zinc stearate at a 40:1 weight ratio (4.8 mole % neutralized) of SMA 1 to zinc stearate;
(5) SMA 1 with zinc stearate at a 24:1 weight ratio (8.1 mole % neutralized) of SMA 1 to zinc stearate;
(6) general purpose polystyrene (GPPS); and
(7) GPPS with zinc stearate at a 24:1 weight ratio of GPPS to zinc stearate.

The MFR of each cavitation agent was measured at 5 kg, 230° C. using ASTM D1238. The results are shown in Table 6.

TABLE 6

| | Average MFR |
|---|---|
| Cavitation Agents | (g/10 min) |
| SMA 1* | 36.8 |
| SMA 1 + 120:1 zinc stearate | 33.8 |
| SMA 1 + 60:1 zinc stearate | 25.1 |
| SMA 1 + 40:1 zinc stearate | 24.9 |
| SMA 1 + 24:1 zinc stearate | 17.9 |
| General Purpose Polystyrene (GPPS)* | 10.5 |
| GPPS + 24:1 zinc stearate* | 30.0 |

*= Comparative

The data in Table 6 demonstrate that an ionomer was formed between SMA 1 and zinc stearate. If an ionomer was not formed, the zinc stearate or acid byproducts would be lubricants, and the MFR would increase as the amount of zinc stearate increases as seen in the case of GPPS.

### Example 4-Comparative

Three-layer films were prepared as described in Example 1, except as noted below.

Each masterbatch contained 60% by weight of the cavitation agent and 40% by weight of mLLDPE 1 as a carrier resin. The cavitation agents were general purpose polystyrene (GPPS) by itself and GPPS blended with zinc stearate at a 40:1 weight ratio of GPPS to zinc stearate. The films were stretched 5×using machine direction orientation (MDO) at 65° C. and annealed at 110° C., relaxing the film 27.8%.

The density and opacity of the resulting films were measured and reported in Table 7.

TABLE 7

Cavitation Agents

| | | GPPS + 40:1 |
|---|---|---|
| | | zinc |
| | GPPS* | stearate* |
| MDO Stretch Temp. | 65 | 65 |
| (° C.) | | |
| Film Gauge | 36 | 34 |
| (μm) | | |
| Film Density | 0.817 | 0.819 |
| (g/cm³) | | |
| Film Opacity | 52.1 | 46.7 |
| (%) | | |

*= Comparative

As seen in Table 7, the density and opacity of the two films are almost the same. As expected, the zinc stearate did not react with the GPPS; without other steps to initiate the reaction, an ionomer was not formed.

### Example 5

Three-layer films were prepared as described in Example 1, except as noted below.

Each masterbatch contained 60% by weight of the cavitation agent and 40% by weight of mLLDPE 1 as a carrier resin. The cavitation agents were neat GPPS and a 2:1 blend by weight of GPPS and SMA 1-zinc stearate ionomer at a 12:1 weight ratio (16.2 mole % neutralized) of SMA 1 to zinc stearate. The films were stretched 5×using machine direction orientation (MDO) at 75° C., and annealed at 110° C., relaxing the film 27.8%.

The density and opacity of the resulting films were measured and reported in Table 8.

TABLE 8

Cavitation Agents

| | | 33% SMA 1 + 12:1 zinc |
|---|---|---|
| | GPPS* | stearate and 67% GPPS |
| MDO Stretch Temp. | 75 | 75 |
| (° C.) | | |
| Film Gauge | 32 | 33 |
| (μm) | | |
| Film Density | 0.851 | 0.820 |
| (g/cm³) | | |
| Film Opacity | 45 | 46.3 |
| (%) | | |

*= Comparative

As seen in Table 8, blending the GPPS with the SMA 1 ionomer improved the density at the 75° C. orientation temperature.

### Example 6

Three-layer films were prepared as described in Example 1, except as noted below.

The skin layers contained mLLDPE 2, and the core layer was loaded with 15% by weight of a cavitation masterbatch letdown with mLLDPE 2. Each masterbatch contained 60% by weight of the cavitation agent and 40% by weight of mLLDPE 4 as a carrier resin. The cavitation agents were SMA 1 ionomer and/or poly(ethylene terephthalate) glycol-modified (PETG). The cavitation agents were blended as follows:
(1) 100 wt % PETG;
(2) 75 wt % PETG with 25 wt % SMA 1 ionomer;
(3) 50 wt % PETG with 50 wt % SMA 1 ionomer;
(4) 25 wt % PETG with 75 wt % SMA 1 ionomer; and
(5) 100 wt % SMA 1 ionomer.

The SMA 1 ionomer in this example had a 34:1 loading by weight of SMA 1 to zinc stearate (5.7 mole % neutralized).

The films were stretched 5×using machine direction orientation (MDO) at 50° C. and annealed at 70° C., relaxing the film 3%.

The density and opacity of the resulting films were measured and reported in Table 9.

TABLE 9

| | Cavitation Agents | | | | |
|---|---|---|---|---|---|
| | | 75% PETG + | 50% PETG + | 25% PETG + | 100% |
| | 100% | 25% SMA 1 | 50% SMA 1 | 75% SMA 1 | SMA 1 |
| | PETG* | Ionomer | Ionomer | Ionomer | Ionomer |
| MDO Stretch | 50 | 50 | 50 | 50 | 50 |
| Temp. | | | | | |
| (° C.) | | | | | |
| Film Density | 0.854 | 0.823 | 0.817 | 0.802 | 0.793 |
| (g/cm³) | | | | | |
| Film Opacity | 51.4 | 50.6 | 44.2 | 37.4 | 37.9 |
| (%) | | | | | |

*= Comparative

As seen from Table 9, a balance of film density reduction and film opacity increase can be achieved by blending an ionomer with PETG as a secondary cavitating component.

### Example 7-Comparative

Three-layer films were prepared as described in Example 1, except as noted below.

The skin layers contained mLLDPE 2 and the core layer was loaded with 15% by weight of a cavitation masterbatch let down with mLLDPE 2. Each masterbatch contained 60% by weight of the cavitation agent and 40% by weight of mLLDPE 5 as a carrier resin. The cavitation agents were: (1) neat PP; and (2) PP-zinc acrylate at a weight ratio of 80:1 polypropylene to zinc acrylate (100 mole % neutralized).

The films were extruded with the barrel and die temperatures set to 190° C. The films were stretched inline on an MDO unit at 65° C. with a draw ratio of 4.5×. These films did not cavitate.

The density and opacity of the resulting films were measured and reported in Table 10.

TABLE 10

Cavitation Agents

| | | PP + 80:1 Zinc |
|---|---|---|
| | PP* | Acrylate* |
| Film Gauge | 34 | 33 |
| (μm) | | |
| Film Density | 0.910 | 0.910 |
| (g/cm³) | | |
| Film Opacity | 6.7 | 6.7 |
| (%) | | |

*= Comparative

### Example 8

Three-layer films were prepared as described in Example 1, except as noted below.

The skin layers contained Zieglar-Natta catalyst (Z-N) LLDPE 1, and the core layer was loaded with 15% by weight of a cavitation masterbatch letdown with Z-N LLDPE 1. The cavitation masterbatch contained 60% by weight of SMA 1 and 40% by weight of Z-N LLDPE 1 as a carrier resin. A neutralization masterbatch containing 2.5% zinc stearate by weight in Z-N LLDPE 1 was added to the core layer of one of the films at 10% by weight. The combination of the neutralization masterbatch and the cavitation masterbatch resulted in an ionomer of SMA 1 with a neutralization level of 5.4 mole % (equivalent to a 36:1 weight ratio of SMA 1 to zinc stearate).

The extrusion temperature was 210° C. The films were stretched at 50° C. to draw ratios of 4.5×, 5.0×, 5.5×, 6.0×, and 6.5× using machine direction orientation (MDO) at 50° C. and annealed at 70° C., relaxing the film 3%.

The density and opacity of the resulting films were measured and reported in Table 11.

TABLE 11

| | |
|---|---|
| Film Density | Film Opacity |
| (g/cm³) | (%) |
| Cavitation Agents | Cavitation Agents |

| | | SMA 1 | | SMA 1 |
|---|---|---|---|---|
| Draw Ratio | SMA 1* | Ionomer | SMA 1* | Ionomer |
| 4.5X | 0.861 | 0.794 | 37.8 | 30.3 |
| 5.0X | 0.863 | 0.787 | 42.9 | 29.2 |
| 5.5X | 0.856 | 0.774 | 42.9 | 30.8 |
| 6.0X | 0.846 | 0.757 | 44.6 | 30.8 |
| 6.5X | 0.834 | 0.736 | 46.7 | 31.9 |

*= Comparative

### Example 9

Three-layer films for tensile testing were prepared as described in Example 1, except as noted below.

The skin layers contained mLLDPE 2, and the core layer was loaded with 15% by weight of a cavitation masterbatch letdown with mLLDPE 2. Each masterbatch contained 60% by weight of the cavitation agent and 40% by weight of mLLDPE 1 as a carrier resin. The cavitation agents were blended as follows:
(1) SMA 1;
(2) SMA 1 ionomer 24:1 ratio (8.1 mole % neutralized);
(3) SMA 1 with stearic acid;
(4) SMA 2;
(5) SMA 2 ionomer 24:1 ratio (4.6 mole % neutralized); and
(6) SMA 2 with stearic acid.

Additionally, a control film of neat mLLDPE 2 was prepared.

The films were not stretched prior to tensile testing.

The films were measured for tensile properties according to ASTM D882. The results are reported in Table 12. The yield stress ratio is the yield stress of the cavitation agent divided by the yield stress of the continuous polymeric phase. In Table 12, the mLLDPE 2 is the continuous polymeric phase.

TABLE 12

| | | | Secant | Yield | |
|---|---|---|---|---|---|
| | | | Modulus | Stress | Yield |
| | Film | | at 1% Strain | MD | Stress |
| | ID | Materials | MD (MPa) | (MPa) | Ratio |
| Cavitation | A | SMA 1* | 180.44 | 10.32 | 1.06 |
| Agents | B | SMA 1 + 24:1 zinc | 116.18 | 8.84 | 0.91 |
| | | stearate | | | |
| | C | SMA 1 + 1.8% | 139.07 | 10.01 | 1.03 |
| | | stearic acid* | | | |
| | D | SMA 2* | 235.3 | 11.72 | 1.21 |
| | E | SMA 2 + 24:1 zinc | 93.84 | 9.47 | 0.98 |
| | | stearate | | | |
| | F | SMA 2 + 1.8% | 235.56 | 10.56 | 1.09 |
| | | stearic acid* | | | |
| Film Core | G | mLLDPE 2* | 102.98 | 9.71 | 1.00 |
| Layer | | | | | |
| Letdown | | | | | |
| Resin | | | | | |

*= Comparative

As seen in Table 12, the films with the ionomer (Films B and E) had a lower yield stress than the films without the ionomer (Films A, C, D, F, and G). The SMA 1 and SMA 2 with stearic acid are not ionomers.

### Example 10

Three-layer films were prepared as described in Example 1, except as noted below.

The skin layers contained mLLDPE 2, and the core layer was loaded with 15% by weight of a cavitation masterbatch letdown with mLLDPE 2. Each masterbatch contained 60% by weight of the cavitation agent and 40% by weight of mLLDPE 4 as a carrier resin. The cavitation agents were:
(1) neat SMA 1;
(2) SMA 1 with zinc acetate dihydrate at a 120:1 weight ratio (4.7 mole % neutralized) of SMA 1 to zinc stearate dihydrate; and
(3) SMA 1 with zinc acetate dihydrate at a 70:1 weight ratio (8.0 mole % neutralized) of SMA 1 to zinc stearate dihydrate.

The films were stretched 5×using machine direction orientation (MDO) at 75° C. and annealed at 110° C., relaxing the film 27.8%.

The density of the resulting films were measured and reported in Table 13.

TABLE 13

| | Film Density (g/cm³) for Various Cavitation Agents | | |
|---|---|---|---|
| MDO Draw | | SMA 1 + 120:1 zinc | SMA 1 + 70:1 zinc |
| Ratio | SMA 1* | acetate dihydrate | acetate dihydrate |
| 4.5X | 0.882 | 0.834 | 0.807 |
| 5.0X | 0.869 | 0.817 | 0.789 |

*= Comparative

As seen in Table 13, the film density decreased with increasing zinc acetate dihydrate loading.

### Example 11-Prophetic

A styrenic-containing polymer without neutralizable units, having a melt flow rate between 30 and 36 g/10 min when measured at 230° C. with a 5 kg weight, and having similar tensile properties (e.g., within 50%) and thermal properties (Tg of approximately 100° C.) as the GPPS given in Table 3, can be grafted with neutralizable units or neutralized units, by techniques known by those skilled in the art. The grafted polymer can have a 1.35% molar ratio of acid equivalents and either already be fully neutralized by zinc or be neutralized by zinc in a subsequent step, resulting in an ionomer. This polymer can then be processed as in Example 10 as a substitute for the SMA 1 and 70:1 ratio of styrene-maleic anhydride copolymer to zinc acetate dihydrate additive into a 1 MI, 0.918 g/cc mLLDPE continuous phase. It can be expected that this ionomer of the styrene-containing polymer would yield similar results as the SMA 1 with 70:1 zinc acetate dihydrate, as well as a marked differentiation in results from unmodified version of the styrene-containing polymer that is not an ionomer.

### Example 12

Ionomers were each made with a 24:1 ratio by weight of the cavitating agent polymer to zinc stearate. Each polymer was melt blended in a Coperion ZSK-26 compounder at 210° C. to 220° C. barrel temperature and 18 kg/hr throughput. Zinc stearate was added with the polymer into the feed throat at 1.5 lbs/hr.

These ionomers along with various other cavitation agents were measured for their elongational viscosity using the Cogswell method defined in the Analytical Methods section. The peak elongational viscosity values were selected in the elongational rate range of 100-500 1/s for each cavitation agent. The results are shown in Table 14.

TABLE 14

| | Elongational Viscosity |
|---|---|
| Cavitation Agent | (Pa · s) |
| SMA 1* | 3,059 |
| SMA 1 Ionomer | 9,913 |
| SMA 2* | 17,023 |
| SMA 2 Ionomer | 24,169 |
| SAN-MAH* | 757 |
| SAN-MAH Ionomer | 13,097 |

*= Comparative

The data in Table 14 show that the ionomers have a much higher elongational viscosity than the corresponding non-ionomers. The non-ionomer elongational viscosity shows each specific polymer's lower-end elongational viscosity, where each polymer has a different initial elongational viscosity. The formation of the ionomer allows tuning of the elongational viscosity.

The higher elongational viscosity is believed to reduce particle deformation during the extrusion process. This results in less particle breakup, which allows for larger particles than a non-ionomer, given the same extrusion conditions. The ionomer particles are likely to be rounder, depending on the extrusion conditions, than the non-ionomer equivalent polymer. A higher elongational viscosity is desirable to create desirable geometry for cavitation.

### Example 13

Six different films were produced with different polyethylene grades (mLLDPE 3, MDPE 1, HDPE 1). Each film contained either SMA 1 or SMA 1 Ionomer. The SMA 1 Ionomer was made with a SMA to zinc stearate ratio of 24:1 by weight. 60% by weight of the SMA ionomer was blended with 40% by weight of a 4.5 MI, 0.918 g/cm³ polyethylene carrier resin in a twin-screw extruder. The films were produced on a three-layer blown film line at 190° C. extruder and die temperatures, 34 kg/hr throughput, 2.25-mm die gap, and 5.4 m/minute primary nip speed. Film gauges ranged from 25-35 micrometers. The films were then imaged via SEM and the average aspect ratio of the particles were measured per the method outlined in the Analytical Methods section. The results are shown in Table 15.

TABLE 15

| | Cavitation Agent Average Inclusion Aspect Ratio | | |
|---|---|---|---|
| Cavitation Agent | mLLDPE 3 Film | MDPE 1 Film | HDPE 1 Film |
| SMA 1* | 6.1 | 15.8 | 7.5 |
| SMA 1 Ionomer | 1.4 | 7.2 | 4.3 |

*= Comparative

The data in Table 15 show that the ionomer in each of the three types of polyethylene continuous phases has a smaller aspect ratio.

The films were then oriented at 85° C. and 4.5×stretch ratio on a machine direction orientation, unless otherwise noted. The films were annealed at 110° C. on two annealing rolls and the annealing-roll draws were set to 0.85×. The density results from the oriented films are shown in Table 16.

TABLE 16

| | Film Density | | |
|---|---|---|---|
| | (g/cm³) | | |
| Cavitation Agent | mLLDPE 3 Film | MDPE 1 Film | HDPE 1 Film |
| SMA 1* | 0.902 | 0.914 | 0.905^{#} |
| SMA 1 Ionomer | 0.810 | 0.836^{#} | 0.804^{#} |

*= Comparative;
^{#}= 4.0X stretch ratio

The data from Table 16 show that the oriented films with SMA 1 Ionomer had a much lower density than the oriented films using SMA 1 cavitation agent. Compared to Table 15, the ionomer cavitation agent has a much lower aspect ratio.

### Example 14

Ionomers were made with a 24:1 ratio by weight of the cavitating agent polymer to zinc stearate, without a carrier resin. Each ionomer was made by melt blending the polymer and zinc stearate in a Coperion ZSK-26 compounder at 240° C. die temperature, 220° C. extrusion temperature, and 18 kg/hr throughput. Each polymer was added to the feed throat along with zinc stearate. The ionomers and non-ionomers were uncarried. The melt flow rate (MFR) was measured for each of the cavitation agents at 230° C., with a 2.1 kg weight. The results of melt flow rate are shown in Table 17.

TABLE 17

| | Melt Flow Rate |
|---|---|
| Cavitation Agent | (g/10 min) |
| SMA 1* | 9.1 |
| SMA 1 Ionomer | 5.5 |
| SMA 2* | 3.3 |
| SMA 2 Ionomer | 0.4 |
| SAN-MAH* | 27.9 |
| SAN-MAH Ionomer | 10.9 |

*= Comparative

It is clear from the data in Table 17 that the formation of an ionomer decreases the MFR when compared to the non-ionomer polymer MFR. Each ionomer will have a different MFR depending on the starting polymer MFR.

### Example 15

SMA 1 and SMA 1 Ionomer (24:1 SMA 1 to zinc stearate by weight loading) were melt blended at a 20 wt % loading into a 1.0 MI, 0.918 g/cm³ polyethylene in a Coperion ZSK-26 compounder at 240° C. die temperature, 220° C. extrusion temperature, and 18 kg/hr throughput. SMA 2, SMA 2 Ionomer, SAN-MAH 1, and SAN-MAH 1 Ionomer were individually melt blended at 20 wt % loading into a 0.5 MI, 0.918 g/cm³ polyethylene in a twin-screw compounder.

Each of the blends was tested in a parallel plate rheometer at 190° C. The individual components zero shear viscosities were measured at 190° C. in a parallel plate rheometer. The inclusion size measurements and calculations were performed using the interfacial tension procedure outlined in the Analytical Methods section. For inclusions that were not spherical, the particle volume was calculated based on the best fit geometric shape (e.g. ellipsoid, cone, rod) and the spherical diameter was calculated for an equivalent volume. The average inclusion diameters were obtained for each inclusion material. The interfacial tension was then calculated for each ionomer and non-ionomer polymer equivalent, and the ratios of the interfacial tensions calculated. In several instances, the non-linear bump in the blend shear-viscosity curve was not visible, meaning its value was at a much lower test frequency, beyond the test equipment capability. Because the rheometer minimum capability was limited to 0.01 radians/second, the shoulder was assumed to be below 0.01 radians/second. In these instances, the non-linear bump frequency was set to 0.01 radians/second for the interfacial tension calculation.

Table 18 shows the ratio of the ionomer to non-ionomer interfacial tension.

TABLE 18

| Cavitation Agents | Interfacial Tension Ratio |
|---|---|
| SMA 1 Ionomer/SMA 1* | 1.8 |
| SMA 2 Ionomer/SMA 2* | 4.3 |
| SAN-MAH Ionomer/SAN-MAH* | 1.7 |

*= Comparative

The data in Table 18 show that forming an ionomer increases the interfacial tension, meaning the interfacial tension ratio is greater than 1.1. This improvement in the interfacial tension is believed to improve particle size and shape.

The invention has been described in detail with particular reference to preferred embodiments thereof, but it will be understood that variations and modifications can be made within the spirit and scope of the invention.

We claim:

1. A composition comprising:
(A) a continuous polymeric phase comprising a polyolefin; and
(B) a cavitation agent dispersed in the continuous polymeric phase,
wherein the cavitation agent comprises one or more ionomers, and
wherein the one or more ionomers exclude ethylene-based ionomers and propylene-based ionomers.

2. The composition of claim 1, wherein the polyolefin comprises an ethylene-based polymer, a propylene-based polymer, or both.

3. The composition of claim 1, wherein at least one ionomer has an average inclusion aspect ratio from 1 to 5, before or after orientation or both.

4. The composition of claim 1, wherein at least one ionomer has a melt flow rate from 0.1 to 35 g/10 minutes when measured according to ASTM D1238 at 230° C. with a 2.1 kg weight.

5. The composition of claim 1, wherein at least one ionomer has a Cogswell elongational viscosity from 100 to 100,000 Pas at any elongation rate from 100 s⁻¹ to 500 s⁻¹.

6. The composition of claim 1, wherein at least one ionomer comprises an ionomer precursor and a cation component; and
wherein the ionomer precursor comprises a styrene-containing polymer, an ester-based polymer, an amide-based polymer, an acrylic-containing polymer, a cyclic olefin copolymer (COC), a non-olefinic biopolymer, a cellulosic polymer, or combinations thereof.

7. The composition of claim 6, wherein the ionomer precursor comprises a styrene-maleic anhydride copolymer (SMA), a styrene-maleimide copolymer (SMI), a styrene-methyl methacrylate copolymer (SMMA), a styrene-acrylonitrile copolymer (SAN), a styrene-acrylonitrile-maleic anhydride copolymer (SAN-MAH), an acrylonitrile-styrene-acrylate copolymer (ASA), an acrylonitrile-butadiene-styrene copolymer (ABS), or combinations thereof.

8. The composition of claim 6, wherein the cation component comprises zinc, sodium, calcium, lithium, magnesium, aluminum, ammonium, or combinations thereof.

9. The composition of claim 8, wherein the cation component comprises zinc.

10. The composition of claim 9, wherein the zinc is sourced from a zinc carboxylate salt, zinc sulfate, or a salt formed in situ from zinc oxide or any combination thereof.

11. The composition of claim 1, wherein at least one ionomer has a molar ratio of acid equivalents to monomer units of 0.1% to 100%, and a neutralization of acid equivalents of 0.5% to 100%.

12. The composition of claim 1, wherein the cavitation agent comprises only ionomer(s).

13. The composition of claim 1, wherein the cavitation agent further comprises a non-ionomeric polymer.

14. The composition of claim 13, wherein the non-ionomeric polymer comprises a styrene-containing polymer, an ester-based polymer, an amide-based polymer, an acrylic-containing polymer, a cyclic olefin copolymer (COC), a non-olefinic biopolymer, a cellulosic polymer, a thermoplastic polyurethane, or combinations thereof.

15. The composition of claim 13, wherein the weight ratio of ionomer(s) to the non-ionomeric polymer is from 1:99 to 99:1.

16. The composition of claim 1, which comprises 0.1 to 40 weight percent of the cavitation agent, based on the total weight of the composition.

17. A cavitated article comprising the composition of claim 1.

18. The cavitated article of claim 17, which is a film, a sheet, a fiber, or a tube.

19. A product comprising the cavitated article of claim 18, wherein the product is a bag, a woven bag, a woven raffia fabric, a label, a shrink label, a shrink film, a laminate, a standup pouch, a wrap, a strap, a ribbon, a strip of film, a tape, a lid, a tray, a bowl, a cup, a bottle, a yarn, a fabric, or clothing.

20. A method of making a cavitated article, the method comprising:
(a) forming a melt comprising the composition of claim 1;
(b) forming an article from the melt;
(c) cooling the article, and optionally heating the article, to an orientation temperature;
(d) orienting the article from step (c) in at least one direction to form a cavitated article; and
(e) optionally, (i) annealing the cavitated article at a temperature higher than the orientation temperature, (ii) allowing the cavitated article to contract in the direction of orientation, or both (i) and (ii); or
(f) optionally, (i) annealing the cavitated article at or below the orientation temperature to retain a desired shrink in the article, (ii) allow the cavitated article to contract in the direction of orientation, or both (i) and (ii).
